(19) United States
(12) Patent Application Publication
(10) Pub. No.: US 2011/0027426 A1
(43) Pub. Date: Feb. 3, 2011

(54) PRODUCT TABLET AND RELATED PACK

(75) Inventor: Gianpaolo Belloli, Bologna (IT)

Correspondence Address: YOUNG & THOMPSON, 209 Madison Street, Suite 500, Alexandria, VA, 22314, US

(73) Assignees: Gianpaolo BELLOLI, Bologna (IT); Erminio DIOLAITI, Bologna (IT); Ippolito IPPOLITO, Bologna (IT)

(21) Appl. No.: 12/808,725

(22) PCT Filed: Dec. 15, 2008
(86) PCT No.: PCT/IB08/03490

§ 371 Date: Jun. 17, 2010

(30) Foreign Application Priority Data
Dec. 18, 2007 (IT) BO2007A000829
May 21, 2008 (IT) BO2008A000316

(51) Int. Cl. B65D 85/804; A23F 5/12; A23F 3/32; A23G 1/50

(52) U.S. Cl. 426/79

(57) ABSTRACT

A tablet (10) of product, in particular in the form of a food product, especially an infusion product such as coffee, tea, cocoa, chocolate, dehydrated stock or other product, includes a tablet body (12) and elements (20) for conveying the infusion liquid. The invention also provides a coffee infusion pack (030) including a supporting member (032) and a compact coffee tablet (010) that is directly supported by, and removable from, the supporting member (032).

### TECHNICAL FIELD

This invention relates to a product tablet.

In particular, the tablet consists of a food product, and especially an infusion product, preferably coffee or tea, cocoa, chocolate, dehydrated stock or other product.

The invention also relates to a pack for a product, in particular an infusion product, preferably in the form of coffee, or in the form of tea, cocoa, chocolate, dehydrated stock or other product.

### BACKGROUND ART

International patent application No. WO2007080492 in the name of the same applicants as this invention discloses a tablet made from a food product for infusion, especially in the form of coffee.

In this regard, the need is felt for a tablet that enables a good infusion to be obtained easily from a corresponding food product.

At present a coffee-based drink can be brewed using powdered coffee in the loose state stored in a respective container which is preferably in the form of a capsule made of rigid plastic or a pod made from two superposed sheets of porous material through which the infusion liquid is made to pass.

The product containing the coffee for preparing the drink is normally stored in a further item of packaging, preferably in the form of a bag made of plastic film or aluminium foil.

In practice, predetermined measured portions of infusion product are provided and can be used conveniently in specific infusion equipment such as coffee machines, coffee pots and the like.

Prior art packs of this kind are not, however, free of disadvantages, particularly on account of the excessive amount of packaging material required, which in turn means high production costs and large amounts of waste that cannot be disposed of conveniently.

Indeed, once prior art packs of this kind have been used, the waste coffee grounds cannot be placed in bins for organic waste and, at the same time, the capsule or pod containing the coffee cannot be placed in the appropriate recycling bins where, for example, plastic is collected for correct disposal.

Thus, these prior art packs, once used, inevitably end up in the bins used for unsorted waste, with obvious disadvantages in terms of waste management and environmental impact.

### SUMMARY OF THE INVENTION

It is provided a tablet of product, in particular in the form of a food product, especially an infusion product, preferably coffee, tea, cocoa, chocolate, dehydrated stock or other product, and comprising a tablet body, characterized in that means are provided for conveying a corresponding fluid.

The specific means for conveying fluid in the tablet body can thus be used to prepare a drink, in particular, an infusion, from the product.

According to another aspect, the invention also provides a pack for a food product, especially in the form of an infusion product, preferably in the form of coffee, or in the form of tea, cocoa, chocolate, dehydrated stock or other product, characterized in that it comprises a supporting member and a product tablet directly supported by, and removable from, said supporting member.

Thus, the product, preferably in the form of coffee, and the supporting member can be conveniently separated for disposal after use.

### BRIEF DESCRIPTION OF THE DRAWINGS

These and other characteristics of the tablet according to the invention are clearly described in the appended claims and its advantages are apparent from the detailed description which follows, with reference to the accompanying drawings which illustrate a preferred non-limiting embodiment of it provided purely by way of example, and in which:

FIG. 1 is a top plan view of a first preferred embodiment of the tablet according to the invention;

FIG. 2 illustrates the first preferred embodiment of the tablet in a section view through the line II-II of FIG. 1;

FIG. 3A is a top view of an enlarged detail of the first preferred embodiment of the tablet, illustrating, in particular, a recess for conveying the infusion liquid;

FIG. 3B is a section view of a detail of the conveying recesses in the first preferred embodiment of the tablet;

FIG. 4 is a top plan view of a second preferred embodiment of the tablet;

FIG. 5 illustrates the second preferred embodiment of the tablet in a section view through the line V-V of FIG. 4;

FIG. 6 is a top plan view of a third preferred embodiment of the tablet according to the invention;

FIG. 7 illustrates the third preferred embodiment of the tablet in a section view through the line VII-VII of FIG. 6;

FIG. 8 is a top plan view of a fourth preferred embodiment of the tablet according to the invention;

FIG. 9 illustrates the fourth preferred embodiment of the tablet in a section view through the line IX-IX of FIG. 8;

FIG. 10A is a section view of a preferred embodiment of an infusion support, or cup, containing an infusion tablet according to the third preferred embodiment and showing also a drinking cup for receiving the infused drink;

FIG. 10B is a section view of a mould used for making a tablet according to the invention to illustrate an advantageous process for making the tablet;

FIG. 11 is a schematic perspective view of a first preferred embodiment of the pack according to the invention;

FIG. 12 illustrates the first preferred embodiment of the pack in a schematic section view through the line XII-XII of FIG. 11;

FIGS. 13A to 13F are perspective views showing different steps in the method of using the pack according to the invention;

FIG. 14 is a schematic perspective view of a second preferred embodiment of the pack according to the invention;

FIG. 15 is a schematic top plan view of a second preferred embodiment of the pack according to the invention;

FIG. 16 illustrates the second preferred embodiment of the pack in a schematic section view through the line XVI-XVI of FIG. 15;

FIG. 17 is a perspective view of a third preferred embodiment of the pack according to the invention;

FIG. 18 is a perspective view of a fourth preferred embodiment of the pack according to the invention;

FIG. 19 is a perspective view of a fifth preferred embodiment of the pack according to the invention.

### DESCRIPTION OF THE PREFERRED EMBODIMENTS OF THE INVENTION

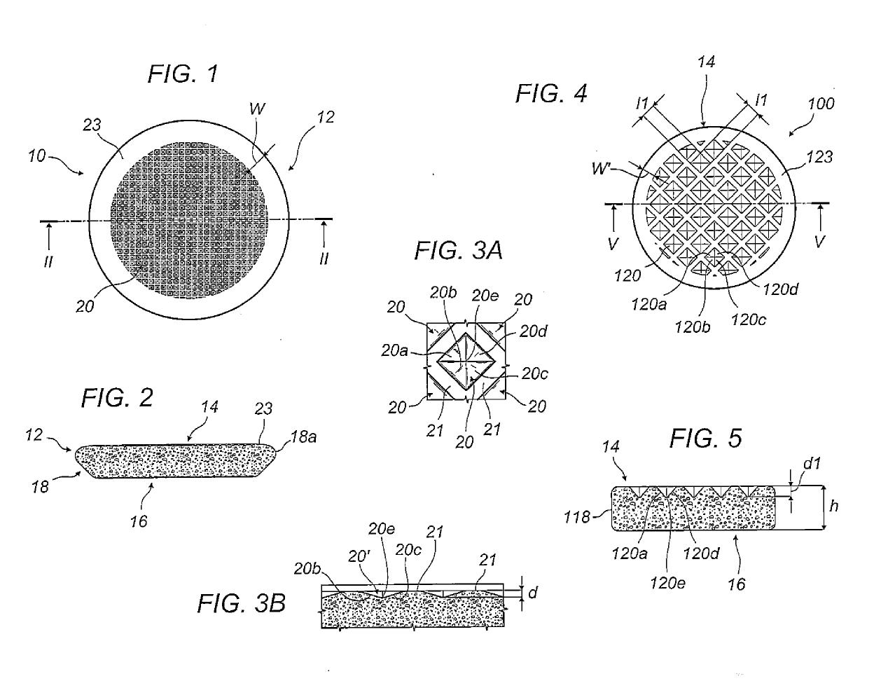

FIGS. 1 to 3B illustrate a first preferred embodiment 10 of a tablet of product, in particular in the form of a food product, especially in the form of an infusion product, preferably coffee.

The infusion product might also be cocoa, chocolate, dehydrated stock or other foodstuff, although coffee is the preferred basic product for making the tablet according to the invention.

As illustrated, the tablet 10 comprises a tablet body 12 having a first and a second transversal face 14, 16—respectively defining, in use, a top transversal face and a bottom transversal face—and a lateral or peripheral face, labelled 18 in FIG. 2.

The tablet advantageously comprises a tablet body with means 20 for conveying or directing a corresponding fluid for extracting the drink from the food product and embodied in particular by an infusion liquid, especially in the form of hot water.

More specifically, the means for conveying, or guiding the extraction fluid are designed to feed, or facilitate the feeding of, the fluid or liquid into the tablet body 12.

In this way, the fluid advantageously and desirably flows into the tablet body and infuses the product.

As may be inferred also from FIGS. 3A and 3B, the tablet body 12 comprises hollow means 20 which open onto a respective face of it, in particular onto the top transversal face 14.

The hollow means comprise at least one hollow and, in particular, advantageously, plurality of hollows 20, arranged in parallel rows.

As illustrated, the hollows 20 are suitably distributed on the respective surface or face 14 of the tablet.

As illustrated, the hollows 20 are closely spaced, being separated from each other only by a short flat portion or surface 21 of the top face 14 of the tablet body 12.

As may be inferred in particular from FIGS. 3A and 3B, each hollow 20 is in the form of a recess having lateral and bottom surfaces 20a, 20b, 20c, 20d that converge at a bottom vertex 20e.

Also, each hollow is open at 20′, on the face 14 of the tablet body 12 in which it is formed and through which the infusion liquid enters.

In practice, the recess 20 has a suitable depth, labelled “d” in FIG. 3B, and extends into the body of the tablet, starting from the respective transversal face or surface, in particular from the top surface 14, forming a mouth or opening 20′ through which the extraction or infusion fluid or liquid flows into the hollow 20 and hence into the tablet body 12.

As illustrated, the hollow 20 has the general shape of a pyramid with a base, forming the access opening, that is quadrangular, and more specifically, square, in shape, the lateral surfaces being flat and converging towards the inside of the tablet.

Although this shape is particularly advantageous, it will be understood that the hollow may have any other desired and suitable shape.

The top face 14 of the tablet body 12 also has a peripheral margin or border 23, in which there are no hollows for conveying the liquid into the tablet body and which, in particular, is in the form of a flat, or flat-shaped, peripheral, or circumferential surface 23.

The flat peripheral margin 23, which extends at a height or level above the bottom of the hollow 20, facilitates the flow of infusion liquid towards the central part of the tablet and hence—through the hollows 20 formed on it—into the body of the tablet 12.

The tablet body also has a bottom transversal surface 16 that can be conveniently rested on the surface of an infusion cup, said bottom surface 16 being, in particular, in the form of a flat transversal surface.

As illustrated, the tablet body has a circular peripheral profile.

As illustrated, the tablet body also has a lateral or peripheral face 18, which diverges upwards and which is, in particular, in the form of a conical face that adapts conveniently to the infusion container.

More specifically, the peripheral or lateral portion or surface of the tablet is suitably shaped to match the profile of a corresponding surface of the infusion container on which it is rested. The container may be a cup forming part of an espresso coffee machine, the filter of a coffee maker or other type of container.

As will become clearer as this description continues, the diverging or conical lateral surface 18 enables the tablet to fit snugly against a corresponding inside lateral surface of an infusion cup or support.

The reference numeral 18a denotes a curved or circumferential edge joining the lateral surface and the top surface 14 of the tablet.

A second preferred embodiment of the tablet according to the invention is illustrated in FIGS. 4 and 5. The parts of the second embodiment that are similar to those of the first embodiment described above are denoted by the same reference numerals and, for brevity, will not be described in detail again.

The second embodiment 100 of the tablet differs from the first embodiment in that it comprises recesses 120 that are larger in size but less in number than those of the first preferred embodiment of the tablet.

In particular, the hollows or recesses 120, which are suitably distributed on the respective surface or face 14 of the tablet, have the general shape of a pyramid, with a quadrangular access opening, and have lateral and bottom surfaces 120a, 120b, 120c, 120d that converge at a bottom vertex 120e. The hollows 120 have a respective height or depth “d1” and width “l1” that are greater than the height and width of the recesses 20 of the first preferred embodiment.

In particular, as may be inferred from FIG. 5, the depth “d1” of the recesses 120 is substantially equal to one quarter of the height “h” of the tablet.

The tablet of the second preferred embodiment also differs from that of the first preferred embodiment in that it has a lateral surface 118 that is cylindrical instead of conical in shape and a height “h” that is greater than the height of the first preferred embodiment.

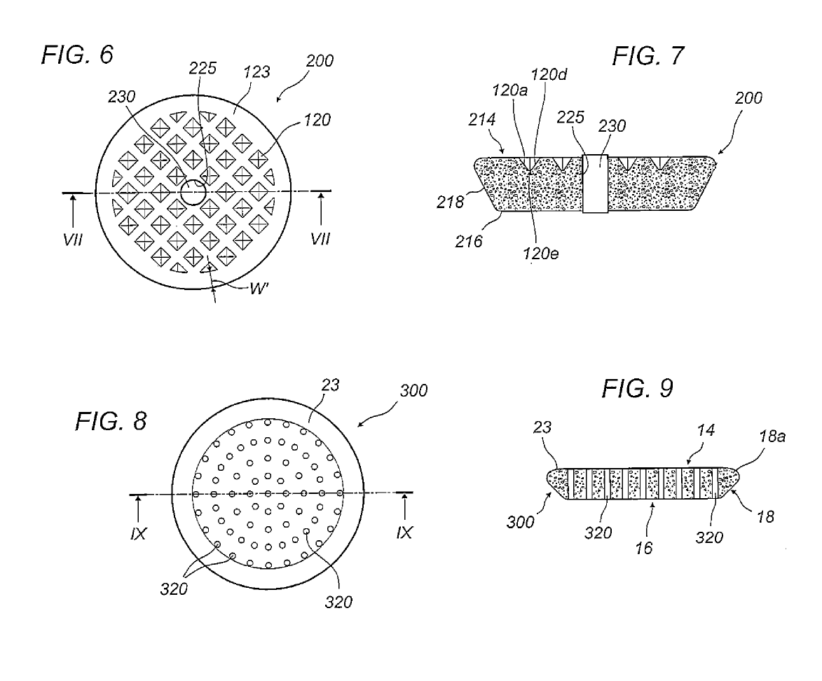

FIGS. 6 and 7 illustrate a third preferred embodiment 200 of the tablet according to the invention, substantially similar to the tablet of the second preferred embodiment from which it differs in that it has a conical, upwardly diverging lateral surface 218 like the first preferred embodiment.

The third embodiment has parts which are similar to those of the other embodiments described above, which, for brevity, will not be described in detail again and which are denoted by the same reference numerals.

The third preferred embodiment of the tablet also has a central hole 225, into which a corresponding pin 230 made of a suitable material, for example plastic, can be inserted, to form advantageous means for conveying or diverting the infusion liquid through the supporting member, and advantageous means for centering the tablet 200 in the infusion cup.

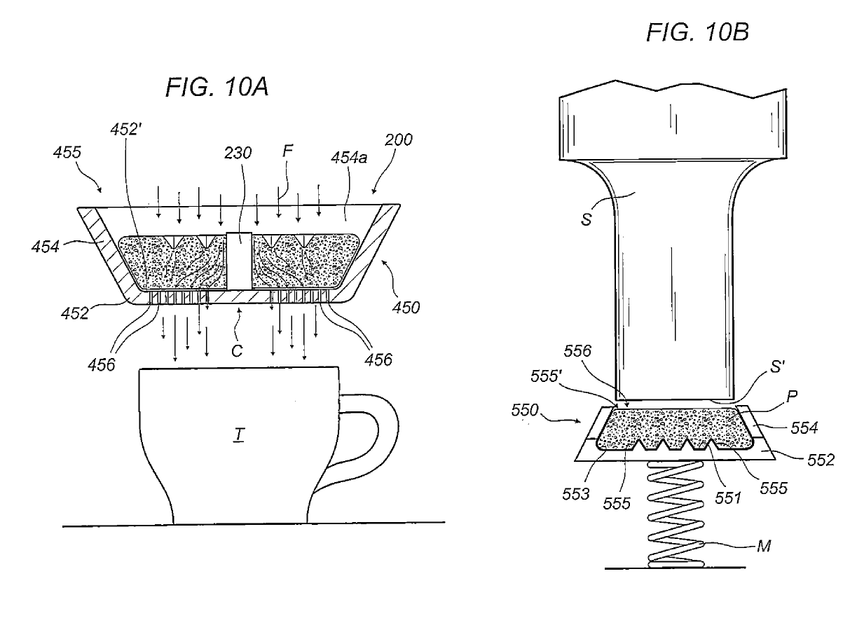

In practice, as may be inferred from FIG. 10A, the liquid flowing longitudinally from the top down is diverted by the pin 230 in a transversal direction, in particular in a radial direction from the centre towards the outside of the tablet.

The cylindrical pin 230 protrudes slightly from the top and bottom of the tablet body, that is to say, relative to the top and bottom surfaces 214 and 216 of the tablet, respectively.

The pin 230 is fitted integrally in a longitudinal hole 225 in the tablet, with its outside surface in contact with, and retained by the cylindrical surface delimiting the longitudinal hole 225.

According to another aspect, it is evident that the tablet of the second and third embodiments have a margin or border 123 whose width W′ is smaller than the width W of the border 23 of the first preferred embodiment.

FIGS. 8 and 9 illustrate a fourth preferred embodiment of the tablet according to the invention, which is labelled 300 in its entirety and which is substantially similar to the first preferred embodiment. The parts of the fourth embodiment that are similar to those of the other embodiments described above are not, for brevity, described in detail again and are denoted by the same reference numerals as those used in the illustrations of the other preferred embodiments.

The fourth preferred embodiment differs from the other embodiments in that it comprises hollow means in the form of holes 320 that pass right through the tablet body. Each of the holes 320 is delimited by a respective, substantially cylindrical surface and extends longitudinally through the tablet body, being open at its respective ends at the top face 14 and bottom face 16 of the tablet body.

Also, the through holes 320 and the respective inlet and outlet openings are suitably distributed in the body and respective surface, or face, of the tablet.

In particular, as illustrated, the through holes 320 and the respective inlet and outlet openings are arranged along concentric, circumferential rows and are radially aligned with each other.

Thus, the holes 320 are suitably spaced from each other and distributed within a central region of the top surface 14 of the tablet body. In practice, each hole 320 is circumferentially and radially spaced from the holes 320 around it.

As will become clearer as this description continues, the tablet is made from a product P in powder or granular form.

As may be inferred from FIG. 10A, the invention also contemplates the provision of a containing support or cup 450, which comprises a bottom wall 452 and a side wall 454 delimiting a space 455 for accommodating the infusion product, and in particular, for accommodating a tablet 200. The bottom wall 452 defines a transversal surface 452′ for engaging the respective transversal face, or underside, 216 of the tablet.

The support is open topped and, on the bottom wall 452, has longitudinal holes 456 through which the infusion liquid can pass.

Advantageously, to enable the infusion liquid to better extract substances from the product, the longitudinal through holes 456 in the bottom wall 454 are spaced from the latter's centre C.

More specifically, the through holes are distributed around a central part C of the bottom wall 452, said central part C being in the form of a full circular surface without holes in it.

Advantageously, the support or cup also has a lateral, or peripheral, inside surface 454a for engaging the lateral surface of the tablet, or infusion product, said peripheral surface 454a having an upwardly diverging, conical shape.

Advantageously, as illustrated, the taper angle of the inside surface 454a of the supporting member or cup is equal or substantially equal to the taper angle of the lateral surface of the product tablet 200.

FIG. 10A illustrates the advantageous infusion method using the tablet and infusion cup 450 according to the invention.

In practice, the liquid, indicated by the arrows F, flows down through the conveying or directing means, is dispersed in the tablet and then, passing through the holes 456 made in the bottom wall of the infusion support or cup 450, drips into a drinking cup, labelled T in the drawings, placed under the infusion cup 450.

The infusion cup 450, generally circular in shape, has convenient surfaces, not illustrated, for engagement to, and retention by, an infusion machine and, if necessary, also has a respective handle, neither illustrated in the accompanying drawings, for supporting and moving it.

FIG. 10B illustrates an advantageous process for making the tablet according to the invention.

The process is substantially similar to that described in international patent application WO2007080492 in the name of the same applicants as this invention and whose contents are incorporated herein by reference.

In brief, the product P, in particular roasted coffee in powder or granular form, is placed in a mould 550 having a bottom face 552, a lateral surface 554 and an opening 556 for inserting the product and applying a sonotrode device S.

Advantageously, the lateral surface 554 of the mould tapers towards the product feed opening 556.

More specifically, the circumferential lateral surface 554 has a conical shape.

The mould 550 advantageously further comprises a bottom wall 552 having corresponding protrusions 555 for forming hollows in the product and extending from a respective inside face 551 of the wall 552.

The bottom wall 552 also has a peripheral surface 553, in particular a suitably flat circular surface forming a respective flat margin around the edge of the product tablet.

In practice, the mould 550 for making the product tablet comprises a bottom wall 552 and a side wall 554 delimiting a space 555′ for accommodating the powdered product, and also has insertion means 555 defining respective hollow means in the tablet body 12.

The insertion means are made on the bottom wall and are in the form of means 555 protruding from the bottom wall 552 itself and having, in particular, a tapered shape converging in the opposite direction to the bottom wall. More specifically, as illustrated, the protruding means are in the form of pointed protrusions 555.

To enable the tablet to be removed from the mould, the bottom wall 552 and the side wall 554 of the mould are movable relative to each other.

The process advantageously comprises adding an aggregating agent, especially in the form of water, to the product P in order to promote aggregation of the product particles. In practice, an aggregating agent, in particular in the form of a liquid, is added to the powdered or granular product.

A predetermined portion of the product is then placed in the mould 550. Next, energy is applied to the predetermined product portion in order to aggregate the product, causing the particles to adhere to each other.

In particularly advantageous manner, the energy is in the form of mechanical vibrations, preferably ultrasound mechanical vibrations.

A tablet is thus obtained where the product particles remain separate but adhere to each other to form a compact, or aggregate, configuration of the powdered or granular product.

In a particularly preferred manner, the aggregating agent, preferably in the form of a liquid, is in the form of water, which does not alter the properties of the product processed. Other liquids, or agents, might also be used, however,

Said agent, in particular in the form of water, is added in a proportion that may vary from 0.1% to 20% by weight of the predetermined product portion. Preferably, the agent, in particular in the form of water, is added in a proportion that varies from 3% to 10% by weight of the predetermined product portion.

Further, the energy applied in the form of mechanical vibrations having a vibration frequency variable from 15,000 to 50,000 Hz, preferably in the ultrasound range and equal or substantially equal to 20,000 Hz.

Further, the predetermined product portion is provided with a quantity of energy between 100 and 5,000 Joules, preferably between 700 and 2,000 Joules, and especially preferably, a quantity of energy equal or substantially equal to 1,500 Joules.

At least part of the aggregating water evaporates during the step of applying energy to the predetermined product portion, in particular during the step of applying the mechanical energy.

As illustrated in FIG. 10B, the mould 550 has an opening 556 at the top of it and the sonotrode S has a face S′ which closes the top opening 556 of the said mould.

Elastic means M, illustrated schematically in the drawing, might also be provided to compress the predetermined product portion.

In practice, once a predetermined portion of product P has been placed in the mould 550, the mould opening 556 is closed with the sonotrode device S and ultrasound energy is applied.

The invention thus provides a tablet of product, in particular in the form of a food product, especially an infusion product such as coffee, tea, cocoa, chocolate, dehydrated stock or other product, comprising means for conveying or directing the infusion liquid into the tablet body, or advantageous means for conveying the infusion liquid through the tablet body.

In another embodiment, the recesses, in particular the recesses 20 or 120 made on the top surface of the tablet might also be provided on the underside of the tablet.

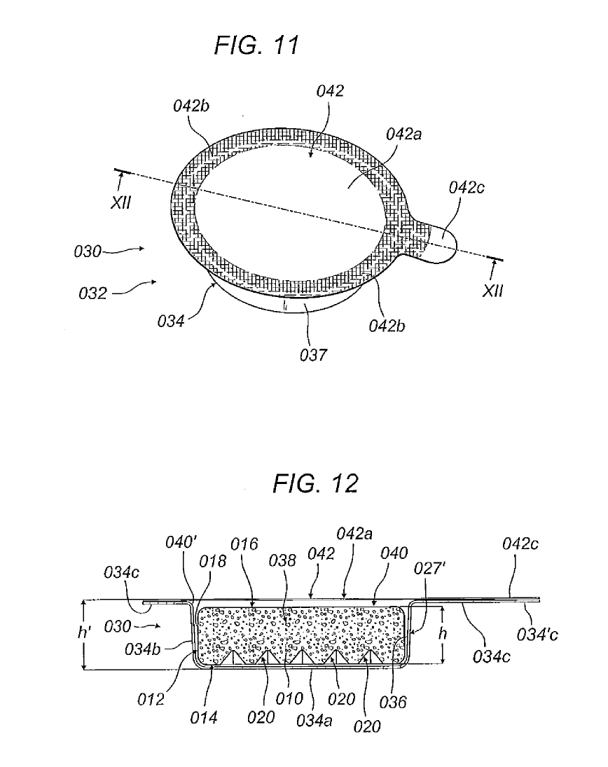

A first preferred embodiment 030 of a pack for a food product, especially in the form of an infusion product, preferably in the form of coffee, or in the form of tea, cocoa, chocolate, dehydrated stock or other product, comprises, as shown in FIGS. 11 to 13F, a supporting member 032 and a coffee tablet 010, in the form of a compact, or rigid, tablet supported by and removable or separable from, the supporting member 032 after use.

In this way, it is possible to dispose of the coffee tablet, in the loose or partly loose or disaggregated form, and the supporting member or element 032 separately, that is to say, to dispose of the coffee tablet in the bin for collecting organic waste and the supporting member in a different bin appropriate for recyclable material, as will become clearer as this description continues.

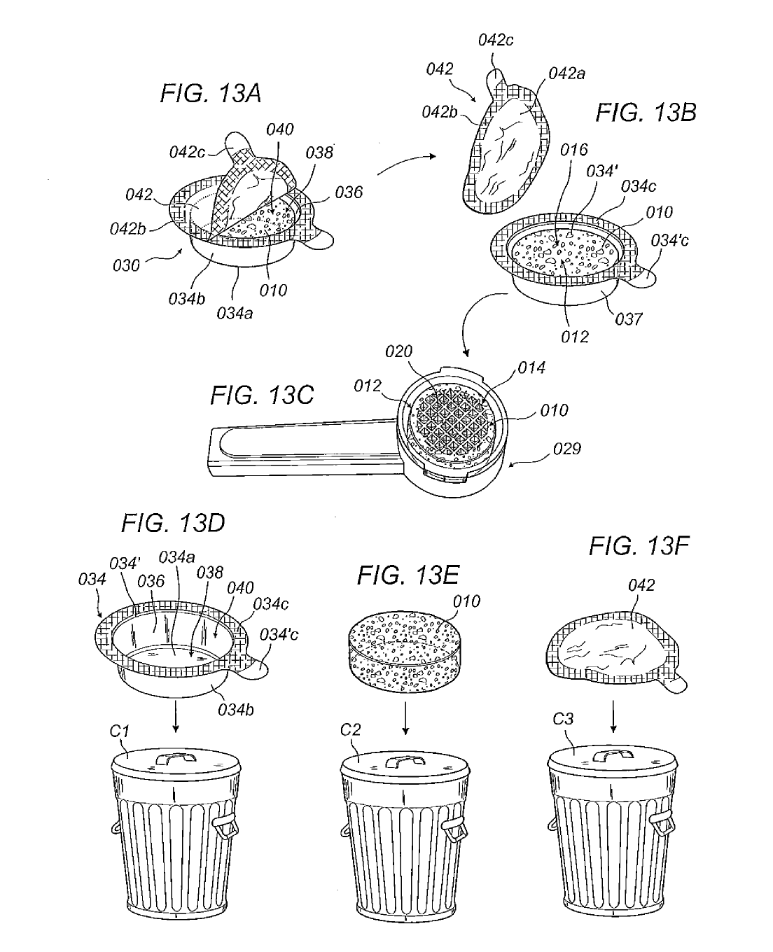

As may be inferred in particular from FIGS. 12, 13B and 13C, the tablet 010 comprises a tablet body 012 having a first and a second transversal face 014, 016—respectively defining, in use, a top transversal face and a bottom transversal face—and a lateral or peripheral face, labelled 018 in FIG. 12.

This tablet 010 is substantially similar to the second preferred embodiment of the tablet described in more detail above and comprises advantageous means 020 for conveying or directing the infusion liquid, or fluid, into the tablet body.

More specifically, the means for conveying or directing the infusion liquid, or fluid, are designed to feed, or facilitate the feeding of, the liquid or fluid into the body 012 of the tablet.

In this way, the liquid advantageously and desirably flows through substantially the whole of the tablet body and infuses the product.

In particular, the tablet body comprises hollow means that open onto a respective top transversal face 014 of the tablet body itself and comprising a plurality of hollows 020 in the form of recesses of suitable depth in the tablet body.

As illustrated, the tablet body 010 also has a substantially flat bottom transversal surface 016 which, in use, forms its underside and which can be conveniently rested on the surface of an infusion cup, for example of the type labelled 029 in FIG. 13C.

As shown in the drawings, the tablet body also has a cylindrical lateral surface 018, with lateral longitudinal surfaces, which might, however, be made in any other suitable desired shape, for example with converging lateral surfaces forming a conical lateral surface as described above.

The tablet 010 might, however, be made as described in international patent application WO2007080492 and Italian patent application BO2007A000829, which are both in the names of the same applicants as this invention and which is incorporated herein by reference.

In practice, this compact, or densified, tablet is made preferably from coffee, in particular roasted coffee, in powder or granular form, placed in a mould to which a sonotrode device, that may be of known type, is applied.

The process advantageously comprises adding an aggregating agent, in particular in the form of a liquid, especially water, to the powdered or granular product in order to promote aggregation of the product particles.

A predetermined portion of the product is then placed in the mould. Next, energy is applied to the predetermined product portion in order to aggregate the product, causing the particles to adhere to each other.

In particularly advantageous manner, the energy is in the form of mechanical vibrations, preferably ultrasound mechanical vibrations.

A tablet 010 is thus obtained where the product particles remain separate but adhere to each other to form a compact, or aggregate, configuration of the powdered or granular product.

As described above, for the tablet 010, too, the aggregating agent, in particular in the form of water, is added in a proportion that may vary from 0.1% to 20% by weight of the predetermined product portion. Preferably, the agent, in particular in the form of water, is added in a proportion that varies from 3% to 10% by weight of the predetermined product portion.

Further, for the tablet 010, too, energy is applied in the form of mechanical vibrations having a vibration frequency variable from 15,000 to 50,000 Hz, preferably in the ultrasound range and equal to 20,000 Hz.

Further, the predetermined product portion is provided with a quantity of energy between 100 and 5,000 Joules, preferably between 700 and 2,000 Joules, and especially preferably, a quantity of energy substantially equal to 1,500 Joules.

At least part of the aggregating water evaporates during the step of applying energy to the predetermined product portion, in particular during the step of applying the mechanical energy.

In a particularly advantageous manner, as illustrated, the supporting member 032 comprises or defines a chamber 038 for accommodating the coffee tablet 010 and also has means defining an opening or outlet 040 through which the solid tablet 010 can be expelled from the supporting element or from the chamber 038.

Advantageously, in the first preferred embodiment, the supporting member is in the form of an element 034, made of rigid or substantially rigid material, preferably thermoformed plastic, or aluminium foil, and is generally in the shape of a cup having an open end forming a product outlet opening 040.

Advantageously, as illustrated, the containing element 034 has an inside surface 036 delimiting the chamber 038 for accommodating the product and having a slightly conical shape that tapers towards the product outlet opening 040. Other shapes for the container 034 are also imaginable, however.

The containing element 034 forms an outer perimetric surface 037 enabling the pack to be easily gripped, the pack being, for this purpose, of a size such that it can be conveniently held between the user's fingers.

In particular, as shown in the drawings, the containing element 034 comprises a transversal bottom surface 034a and lateral or circumferential surface 034b.

Advantageously, as may be clearly inferred from FIGS. 11 and 12, the supporting member 032 has a chamber 038 for accommodating the product and whose dimensions, in particular length or height, are such as to contain a single tablet 010.

More specifically, the tablet has a height h that is slightly less than the height h′ of the product chamber 038.

Further, the diameter of the inside surface 036 delimiting the product chamber 038 is slightly greater than the diameter of the tablet 010.

The first embodiment of the pack also comprises means 042 for closing the opening 040, said closing means being advantageously able to be opened to allow the tablet 010 to be expelled.

The means for closing the opening 040 of the supporting member 030 are in the form of a film or layer of material that is disengageably associated with, or peelable from, the supporting member 030.

In particular, the layer or film of material 042, defining the means for closing the containing element, is in the form of an aluminium foil associated with the containing element 034, peripherally of the tablet outlet opening 040, by means of a respective layer of adhesive provided on the inside face, or underside, of the closing film 042.

As illustrated, the closing means 042 are associated with the containing element 034 along a transversal lip 034c extending circumferentially and protruding radially from the edge of the containing element 034 which delimits the opening or tablet outlet 040. The edge that delimits the opening 040 is denoted by the reference numeral 034′.

The closing means 042, besides a main portion 042a for sealing, or screening, the product outlet opening, and a circumferential portion 042b for connection to the lip 034c of the containing element 034, also comprise a radially protruding grip tab 042c for opening the pack.

The transversal lip 034c also has a radially protruding portion 034′c for supporting the grip tab 042c used to open the pack.

As shown in FIGS. 13A, 13B and 13C, the tablet 010, in use, has a top end or face 014 and a bottom end or face 016.

As may be inferred from FIGS. 13A and 13B, the tablet 010 fits into the containing element 034 with the bottom face or end 016 facing the outlet opening 040, that is to say, with the top face or end 014 resting on the bottom 034a of the containing element so that the tablet can be easily and conveniently placed correctly inside the infusion apparatus 029 without the user having to touch the tablet with his/her hands. That means the operation can be carried out totally hygienically.

Briefly, in the process using the pack according to the invention an unused pack 030, illustrated in FIG. 11, can be opened by removing the aluminium foil 042 from the containing element 034, as shown in FIGS. 13A and 13B, and the tablet 010 allowed to drop into the infusion cup 029 of the infusion machine, as shown in FIG. 13C, or into another container, such as the filter of a coffee maker, by holding between the fingers only the outside surface of the container 034, in particular the latter's perimetric surface 037. The containing element 034 can then be disposed of in a suitable bin C1, for example a bin for the collection of plastic, and the used coffee grounds can be disposed of in a bin C2 for the collection of organic waste. The aluminium foil or other film 042, defining the means for closing the pack according to the invention can in turn be disposed of in a respective bin C3, for example a bin for the collection of unsorted waste.

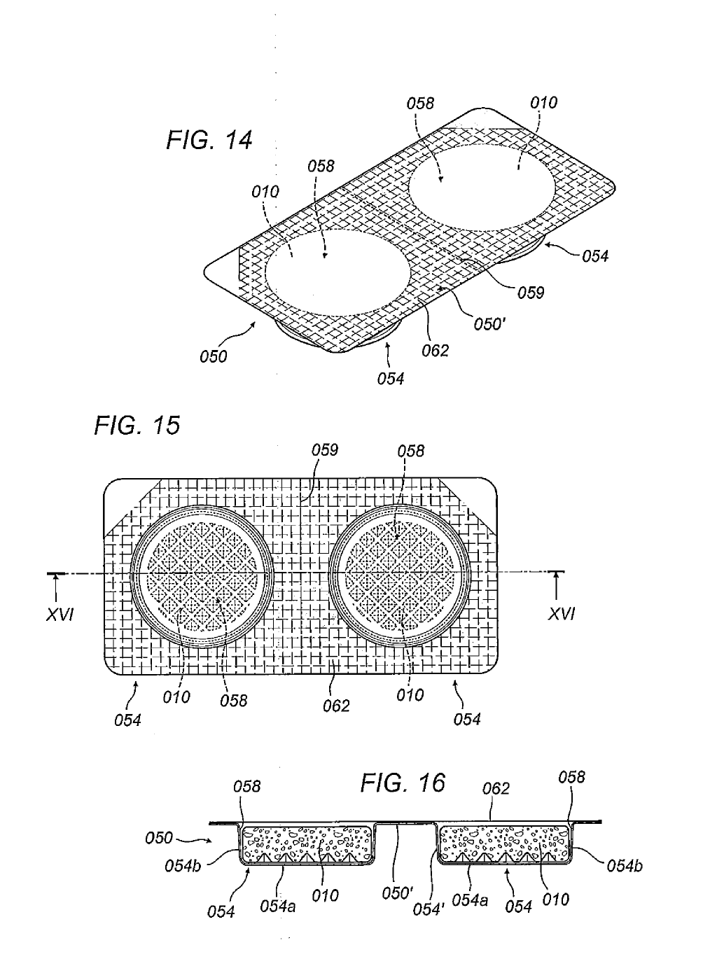

A second preferred embodiment 050 of the pack according to the invention, illustrated in FIGS. 14 to 16, comprises a plurality of chambers for containing corresponding product tablets 010, 010, in particular in the form of a first and a second containment chambers 058, 058.

In practice, in the second preferred embodiment 050, the body of the pack comprises a plurality of parts, in particular a first and a second part 054, 054, each of which comprises a respective containment chamber 058, 058, said parts 054, 054, being advantageously and conveniently separable from each other.

More in detail, as illustrated, the pack 050 comprises a supporting member made of rigid, or substantially rigid, plastic material and forming a transversal layer or wall 050′, from which there extend a first and a second containment pocket, or chamber, 058, 058, placed side by side, for accommodating respective tablets 010, 010.

The containment body 050 thus comprises a flat sheet 050′ from which there extend respective longitudinal walls or surfaces 054b, 054b, slightly conical or cylindrical in shape and each ending with a respective transversal bottom surface 054a, 054a.

The flat sheet 050′ forms a transversal lip which extends around the respective chamber 058 and which is associated with a film 062 forming removable or peelable means for closing the respective outlet opening for expelling the tablet from the chamber 058, 058, the film 062 being the same as that of the first preferred embodiment and thus not being described again in detail.

Means are also provided for separating one supporting part 054 from the other supporting part 054, the separating means being preferably in the form of a pre-weakened line 059 provided on the flat transversal wall 050′ in the section where said wall joins the first and second containment chambers 058, 058.

The second preferred embodiment 050 of the pack might be packaged in a box or case and used in exactly the same way as the first preferred embodiment of the pack after simply separating one of the parts 054 containing a respective containment chamber 058 from the other part 054.

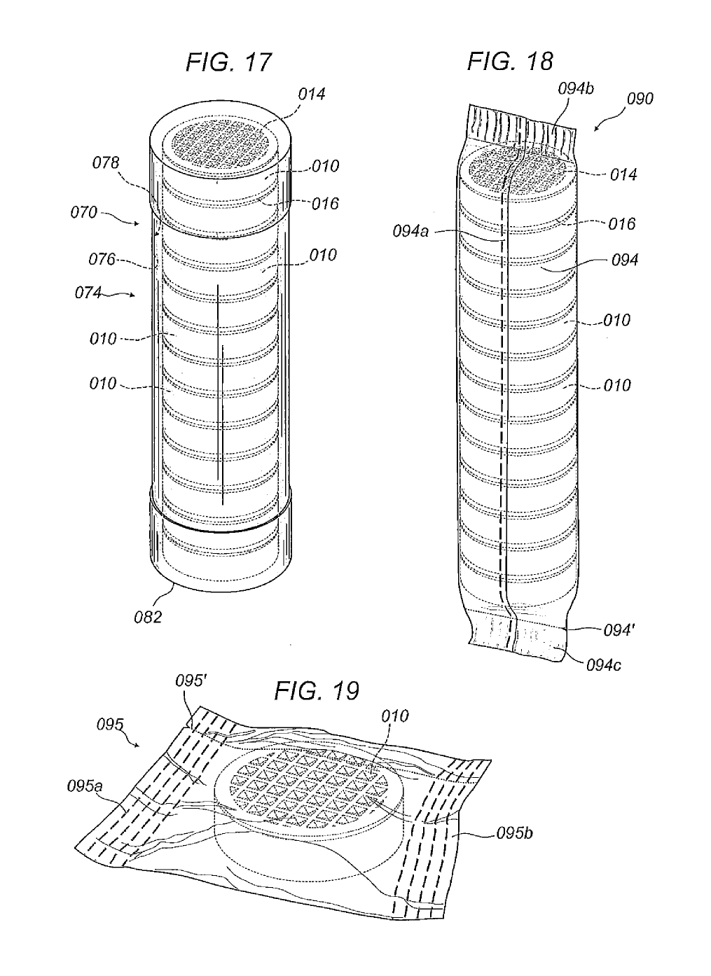

FIG. 17 illustrates a third preferred pack embodiment 070 comprising a body made of a rigid material, cylindrical in shape and provided with a respective containment chamber 078 designed to accommodate a plurality of tablets 010 placed over one another in a pile.

In practice, the product tablets 010 are axially or longitudinally aligned, their respective transversal faces being in contact with one another.

The pack 070 has a cap or closing element 082 which closes a respective opening, not illustrated in detail in FIG. 17, from which the tablets 010 can be dispensed in sequence.

The containment body 074 is in the form of a cylindrical, tubular element, open at the end that is closed by the cap 082 and made of a suitable material such as, for example, plastic or paperboard.

In use, as in the first preferred embodiment, each tablet 010 has a top surface 014 a bottom surface 016 and a lateral surface.

The tablets are located in the container 070 with the bottom surface 016 facing the product outlet opening.

The following FIG. 18 illustrates a multiple pack similar to that of FIG. 17.

In practice, a fourth preferred pack embodiment comprises a plurality of coffee tablets 010 placed over one another in a pile but, unlike the third preferred embodiment, being in the form of a bag made of plastic film wrapped around the product contained.

The fourth preferred pack embodiment 090 basically comprises a film wrapped in a tube around the product tablets and having a longitudinal seal 094a, and transversal seals 094b, 094c.

The bottom end 094c is provided with means for facilitated opening of the film 094 and which may be embodied by any suitable means such as, for example, by a pre-weakened line or, as in this case, by a simple tear cut or notch 094′ to make it easier to tear the wrapping open.

In this preferred embodiment, too, the tablets 010, in use, have a top surface 014 and a bottom surface 016 and are placed in the pack in such a way that the bottom surface 016 of each faces the product outlet or dispensing end 094c, that is to say, the area provided with the means 094′ for opening the pack 090.

FIG. 19 shows a fifth pack embodiment 095 similar to the fourth embodiment in that it comprises a bag made from a film wrapped around the product and having transversal seals 095a, 095b and a longitudinal seal not illustrated in FIG. 19.

In this fifth embodiment the size of the bag 095 is such as to contain a single tablet 010.

In this embodiment, the tablet 010 is positioned substantially in the same plane as, and parallel with, the transversal seals 095a, 095b.

The reference 095′ in FIG. 19 denotes a pre-weakened tear line to facilitate opening of the wrapping 095.

In the first and second preferred embodiments, the containment element is made preferably of a laminated plastic barrier film that is suitably thermoformed. The containment element might also be made of cold formed or erectable aluminium foil or of any other suitable material.

With the pack according to the invention, the compact coffee tablet can be positioned directly in the infusion device, for example in the coffee holding cup 029 of the infusion machine or the like, without touching or contaminating the tablet.

The above described preferred embodiments of the pack and of the coffee infusion tablet, which is substantially compact or rigid, that is to say, densified and such as to maintain the shape imparted to it by the mould used to make it and which is housed or supported directly by a supporting member, allow considerable savings in packaging materials compared to prior art packs and also reduce the environmental impact by facilitating their disposal as waste after use.

In the first and second embodiments of it, the invention advantageously contemplates the provision of closing means which can be completely removed from the containment element and which, as described above, are made of a different material so that they can be disposed of in a waste bin different from the waste bins used to dispose of the containment element and of the coffee grounds.

In practice, with the pack according to the invention, the containment element and the coffee grounds can be disposed of in different waste bins with a view to recycling them. For example, as described herein, the containment element can be disposed of in the bin for collecting plastic and the coffee grounds can be disposed of in the bin for collecting organic waste. Further, as mentioned, the aluminium foil of which the peelable or removable means for closing the pack are made can be conveniently disposed of in a bin for collecting unsorted waste or in another specific waste bin.

The invention described above is susceptible of industrial application and may be modified and adapted in several ways without thereby departing from the scope of the inventive concept. Moreover, all the details of the invention may be substituted by technically equivalent elements.

1-96. (canceled)

97. A tablet (10) of product in the form of a food product, the product being an infusion product, preferably in the form of coffee, or in the form of tea, cocoa, chocolate, dehydrated stock or other product, comprising a tablet body (12); wherein it comprises means for conveying the fluid through the tablet body comprising hollow means (20) which open onto a respective top transversal face (14) of the tablet body (12); wherein the hollow means comprise a plurality of hollows (20) distributed on the respective face of the tablet; and wherein each cavity is in the form of a recess having lateral and bottom surfaces (20a, 20b, 20c, 20d) and an opening (20′).

98. The tablet according to claim 97, wherein the hollows (20) are arranged in parallel rows.

99. The tablet according to claim 97, wherein the hollows (320) are arranged according to a circumferential row.

100. The tablet according to claim 99, wherein the hollows (320) are arranged according to a plurality of concentric, circumferential rows.

101. The tablet according to claim 97, wherein the hollows (20) are adjacent to each other.

102. The tablet according to claim 101, wherein the hollows (20) are closely spaced and separated from each other by a portion (21) of the top face (14) of the tablet body.

103. The tablet according to claim 97, wherein the hollows (320) are spaced from each other.

104. The tablet according to claim 97, wherein each hollow has an opening that is quadrangular in shape, and in particular, square in shape.

105. The tablet according to claim 97, wherein each cavity has lateral surfaces (20a, 20b, 20c, 20d) converging towards the inside of the tablet.

106. The tablet according to claim 105, wherein each cavity has lateral surfaces (20a, 20b, 20c, 20d) which are substantially flat.

107. The tablet according to claim 97, wherein the tablet comprises a flat peripheral margin (23) on its top face (12).

108. The tablet according to claim 97, wherein the tablet body has a bottom transversal face (16).

109. The tablet according to claim 97, wherein the tablet body has a flat bottom face (16).

110. The tablet according to claim 97, wherein the tablet body has a circular profile.

111. The tablet according to claim 97, wherein the tablet body comprises an upwardly diverging lateral face (18).

112. The tablet according to claim 97, wherein the tablet body comprises a conical lateral face (18).

113. The tablet according to claim 97, wherein the tablet comprises a curved circumferential edge (18a) joining the top transversal face (14) to the lateral face (18) of the tablet body.

114. The tablet according to claim 97, wherein it comprises a pin (230) inserted in the tablet body (12).

115. The tablet according to claim 114, wherein the pin (230) is inserted centrally in the tablet body.

116. The tablet according to claim 114, wherein the pin (230) is inserted in a longitudinal hole (225) in the tablet body.

117. The tablet according to claim 114, wherein the pin (230) is integral with the tablet body.

118. The tablet according to claim 97, wherein the tablet is made from roasted coffee, in powder or granular form.
